(19) United States
(12) Patent Application Publication
(10) Pub. No.: US 2019/0299142 A1
(43) Pub. Date: Oct. 3, 2019

(54) HONEYCOMB FILTER

(71) Applicant: NGK Insulators, Ltd., Nagoya-City (JP)

(72) Inventor: Takashi AOKI, Nagoya-City (JP)

(73) Assignee: NGK Insulators, Ltd., Nagoya-City (JP)

(21) Appl. No.: 16/353,273

(22) Filed: Mar. 14, 2019

(30) Foreign Application Priority Data
Mar. 27, 2018 (JP) 2018-060159

(51) Int. Cl. B01D 46/24

(52) U.S. Cl. CPC B01D 46/244; B01D 2279/30; B01D 2046/2496

(57) ABSTRACT

A honeycomb filter includes a honeycomb structure including a porous partition wall surrounding cells, porous inflow side plugging portions and porous outflow side plugging portions. Each inflow side plugging portion includes, on an inflow side, a low porosity part having a porosity P1(%) of 70% or less and includes, on an outflow side, a high porosity part having a higher porosity than the low porosity part. The high porosity part has a porosity P2(%) satisfying P2≥(0.8904×P3)+(0.7716×N1)−37.585, where P3(%) represents a porosity (%) of the partition wall; and N1(%) represents an open frontal area (%) of the cells, and the high porosity part has a length of 1 mm or more.

The present application is an application based on JP 2018-060159 filed on Mar. 27, 2018 with Japan Patent Office, the entire contents of which are incorporated herein by reference.

### BACKGROUND OF THE INVENTION

### Field of the Invention

The present invention relates to a honeycomb filter. More specifically, the present invention relates to a honeycomb filter capable of preventing plugging portions provided to plug open ends of cells from falling from the cells and of preventing erosion of the plugging portions by foreign substances.

### Description of the Related Art

As a filter for trapping particulate matters in the exhaust gas emitted from an internal combustion engine such as a diesel engine or as an apparatus for purifying poisonous gaseous components such as CO, HC, and NOx, a honeycomb filter having a honeycomb structure has been used (see Patent Document 1). The honeycomb structure has a partition wall formed from a porous ceramic such as cordierite and silicon carbide, and the partition wall defines a plurality of cells. The honeycomb filter has such a honeycomb structure as described above, and in the honeycomb structure, plugging portions are so provided as to alternately plug open ends of a plurality of cells on the inflow end face side and open ends on the outflow end face side. In other words, the honeycomb filter has the structure in which inflow cells each having an open inflow end and a plugged outflow end and outflow cells each having a plugged inflow end and an open outflow end are alternately arranged while a partition wall is interposed therebetween. In the honeycomb filter, the porous partition wall of the honeycomb structure functions as a filter for trapping particulate matters in an exhaust gas. Hereinafter, the particulate matter contained in an exhaust gas is also called “PM”. “PM” is the abbreviation of “particulate matter”.

In recent years, the honeycomb filter for purifying the exhaust gas emitted from an engine of an automobile or the like is required to reduce pressure loss in order to improve the fuel efficiency of an automobile, for example. To reduce the pressure loss, as well as a “reduction in wall thickness” of reducing the thickness of a partition wall of a honeycomb structure, “giving a higher porosity” of further increasing the porosity of a partition wall as compared with a conventional partition wall has been studied.

In the honeycomb filter, plugging portions are provided on the inflow end face side and outflow end face side at ends of cells, and thus the honeycomb structure may have different Young's moduli between the ends with the plugging portions on the inflow end face side and outflow end face side and the portions without the plugging portions. A honeycomb structure having a smaller wall thickness and a higher porosity is likely to have a larger difference in Young's modulus between the portions with the plugging portions and the other portions. In such a honeycomb filter, stress is likely to be generated on the boundary between the portions with the plugging portions and the other portions, and the plugging portions are likely to fall from the ends of the cells. For example, when a honeycomb filter is stored in a case such as a metal case for connection to an air exhaust pipe of an automobile or the like, the plugging portions may fall from the ends of the cells due to the bearing stress applied to the circumferential face of the honeycomb filter. When the PM trapped by a honeycomb filter is burned and removed to regenerate the honeycomb filter, stress is also likely to be generated on the above boundary, and the plugging portions may fall from the ends of the cells. On this account, to plug open ends of the cells in a honeycomb structure having a higher porosity, plugging portions also having a higher porosity may be provided to reduce a local difference in Young's modulus of the honeycomb structure.
[Patent Document 1] JP-A-2009-195805

### SUMMARY OF THE INVENTION

When plugging portions having a higher porosity are provided in a honeycomb structure having a higher porosity, the honeycomb structure has a smaller local difference in Young's modulus, and the plugging portions are unlikely to fall from the ends of the cells. However, when foreign substances such as metal particles generated from an engine or an exhaust pipe come flying on the stream of an exhaust gas, the plugging portions having a higher porosity are unfortunately, severely abraded by collision of the foreign substances. In particular, recent plugging portions having a higher porosity may be wholly scraped away by foreign substances, and finally, the plugging portions may be lost from the open ends of the cells, resulting in a honeycomb filter with no filtering function. Hereinafter, abrasion or scraping of a plugging portion or the like by foreign substances coming flying on the stream of an exhaust gas is also called “erosion”.

In view of the above circumstances, the present invention has been made. The present invention is intended to provide a honeycomb filter capable of preventing plugging portions provided to plug open ends of cells from falling from the cells and of preventing erosion of the plugging portions by foreign substances.

According to the present invention, the following honeycomb filters are provided.

[1] A honeycomb filter comprising:

a pillar-shaped honeycomb structure including a porous partition wall provided to surround a plurality of cells serving as fluid passages extending from an inflow end face to an outflow end face;

inflow side plugging portions provided on a side of the inflow end face at ends of predetermined cells of the plurality of cells; and

outflow side plugging portions provided on a side of the outflow end face at ends of residual cells of the plurality of cells, wherein

the inflow side plugging portions and the outflow side plugging portions are formed from a porous body,

each inflow side plugging portion includes, on a side of the inflow end face in an extending direction of the cells, a low porosity part having a porosity P1(%) of 70% or less and includes, on a side of the outflow end face in an extending direction of the cells, a high porosity part having a higher porosity than the low porosity part,

the high porosity part has a porosity P2(%) satisfying Formula (1), and

the high porosity part has a length L2 (mm) of 1 mm or more in the extending direction of the cells.

P2≥(0.8904×P3)+(0.7716×N1)−37.585 Formula (1):

(In Formula (1), P3(%) represents a porosity (%) of the partition wall; and N1(%) represents an open frontal area (%) of the cells in the honeycomb structure)

[2] The honeycomb filter according to [1], wherein the low porosity part has a length L1 (mm) satisfying Formula (2) in the extending direction of the cells:

L1≥0.1339×P1−7.517 Formula (2):

(in Formula (2), P1(%) satisfies 65%<P1≤70%).

[3] The honeycomb filter according to [1], wherein the low porosity part has a length L1 (mm) satisfying Formula (3) in the extending direction of the cells:

L1≥0.0245×P1−0.4375 Formula (3):

(in Formula (3), P1(%) satisfies 40%<P1≤65%).

[4] The honeycomb filter according to [1], wherein the low porosity part has a porosity P1(%) of 40% or less and has a length L1 (mm) satisfying Formula (4) in the extending direction of the cells:

L1≥0.4. Formula (4):

[5] The honeycomb filter according to any one of [1] to [4], wherein the high porosity part has a length L2 (mm) of 1 to 9.5 mm in the extending direction of the cells.

[6] The honeycomb filter according to any one of [1] to [5], wherein the low porosity part has a porosity P1(%) of 5 to 70%.

[7] The honeycomb filter according to any one of [1] to [6], wherein an absolute value of a difference between the porosity P2(%) of the high porosity part and the porosity P1(%) of the low porosity part is 1 to 75%.

The honeycomb filter of the present invention can prevent inflow side plugging portions provided to plug open ends of cells from falling from the cells and can prevent erosion of the inflow side plugging portions by foreign substances. Especially in a honeycomb filter including a honeycomb structure having a higher porosity, by setting each high porosity part designed to satisfy Formula (1) to have a length L2 (mm) of 1 mm or more in the cell extending direction, the inflow side plugging portions can be effectively prevented from falling from the cells. In addition, each inflow side plugging portion includes a low porosity part having a relatively low porosity on the inflow end face side, and thus the erosion by foreign substances can be effectively prevented.

### BRIEF DESCRIPTION OF THE DRAWINGS

FIG. 1 is a schematic perspective view showing an embodiment of a honeycomb filter of the present invention;

FIG. 2 is a plan view showing an inflow end face side of the honeycomb filter shown in FIG. 1;

FIG. 3 is a plan view showing an outflow end face side of the honeycomb filter shown in FIG. 1;

FIG. 4 is a schematic sectional view taken along the line A-A′ in FIG. 2;

FIG. 5 is a schematic sectional view showing another embodiment of the honeycomb filter of the present invention;

FIG. 6 is a schematic sectional view showing still another embodiment of the honeycomb filter of the present invention.

### DESCRIPTION OF THE PREFERRED EMBODIMENTS

Embodiments of the present invention will now be described, but the present invention is not intended to be limited to the following embodiments. It should therefore be understood that changes, improvements, and other modifications appropriately made in the embodiments described below on the basis of ordinary knowledge of a person skilled in the art are also encompassed in the present invention without departing from the scope of the present invention.

(1) Honeycomb Filter:

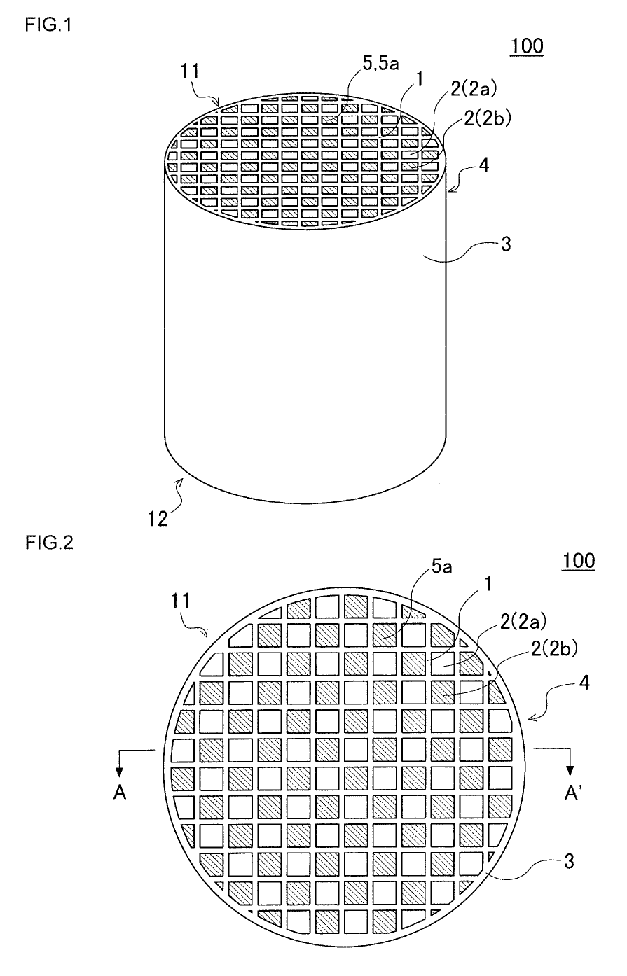

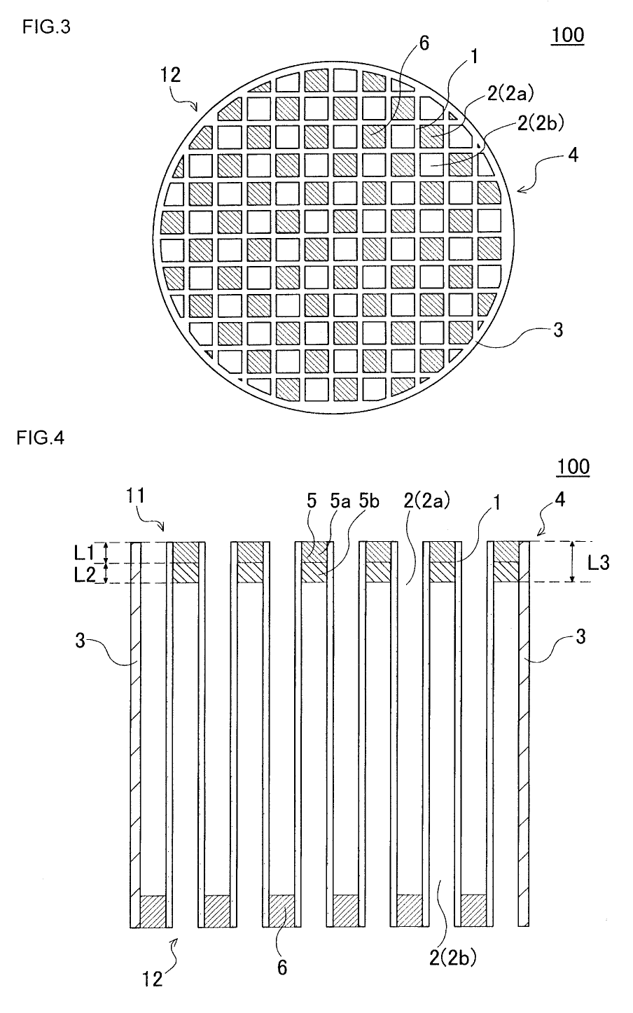

An embodiment of the honeycomb filter of the present invention is a honeycomb filter 100 as shown in FIG. 1 to FIG. 4. FIG. 1 is a schematic perspective view showing an embodiment of the honeycomb filter of the present invention. FIG. 2 is a plan view showing an inflow end face side of the honeycomb filter shown in FIG. 1. FIG. 3 is a plan view showing an outflow end face side of the honeycomb filter shown in FIG. 1. FIG. 4 is a schematic sectional view taken along the line A-A′ in FIG. 2.

As shown in FIG. 1 to FIG. 4, the honeycomb filter 100 includes a honeycomb structure 4, inflow side plugging portions 5, and outflow side plugging portions 6. The honeycomb structure 4 has a porous partition wall 1 provided to surround a plurality of cells 2 serving as fluid passages extending from an inflow end face 11 to an outflow end face 12. The honeycomb structure 4 is a pillar-shaped structure having the inflow end face 11 and the outflow end face 12 as the respective end faces. In the honeycomb filter 100 of the embodiment, the honeycomb structure 4 further has, on the circumferential side face thereof, a circumferential wall 3 provided to environ the partition wall 1.

The inflow side plugging portions 5 are provided on the side of the inflow end face 11 at the ends of predetermined cells 2 of the plurality of cells 2. Hereinafter, a cell 2 having an inflow side plugging portion 5 at the end on the side of the inflow end face 11 is also called “outflow cell 2b”. The outflow side plugging portions 6 are provided on the side of the outflow end face 12 at the ends of the residual cells 2 of the plurality of cells 2 (i.e., cells 2 other than the outflow cells 2b). Hereinafter, a cell 2 having an outflow side plugging portion 6 at the end on the side of the outflow end face 12 is also called “inflow cell 2a”. The inflow side plugging portions 5 and the outflow side plugging portions 6 are formed from a porous body. In the present specification, the inflow side plugging portions 5 and the outflow side plugging portions 6 are also generically, simply called “plugging portions”.

The honeycomb filter 100 of the embodiment is mainly characterized in that the inflow side plugging portions 5 have the following structure. In other words, each inflow side plugging portion 5 includes, on the side of the inflow end face 11 in the extending direction of the cells 2, a low porosity part 5a having a porosity P1(%) of 70% or less and includes, on the side of the outflow end face 12 in the extending direction of the cells 2, a high porosity part 5b having a higher porosity than the low porosity part 5a. The high porosity part 5b has a porosity P2(%) satisfying Formula (1). The high porosity part 5b has a length L2 (mm) of 1 mm or more in the extending direction of the cells 2.

P2≥(0.8904×P3)+(0.7716×N1)−37.585 Formula (1):

(In Formula (1), P3(%) represents the porosity (%) of the partition wall 1; and N1(%) represents the open frontal area (%) of the cells 2 in the honeycomb structure 4)

In the specification, the open frontal area (%) of the cells 2 in a honeycomb structure 4 is the percentage of the ratio of the total open area S2 of the plurality of cells 2 to the total area S1 of a cross section orthogonal to the extending direction of the cells 2 of the honeycomb structure 4. The “total open area S2 of the plurality of cells 2” means the total open area in the honeycomb structure of the honeycomb structure 4 while the plugging portions (inflow side plugging portions 5 and outflow side plugging portions 6) are not considered.

The honeycomb filter 100 having such a structure can prevent the inflow side plugging portions 5 from falling from the cells 2 and can prevent erosion of the inflow side plugging portions 5 by foreign substances. Especially in a honeycomb filter 100 including a honeycomb structure 4 having a higher porosity, by setting the high porosity part 5b of each inflow side plugging portion 5 to have a length L2 (mm) of 1 mm or more in the extending direction of the cells 2, the inflow side plugging portions 5 can be prevented from falling from the cells 2. In addition, each inflow side plugging portion 5 includes a low porosity part 5a having a relatively low porosity, and thus the erosion by foreign substances can be effectively prevented.

If the low porosity part 5a has a porosity P1(%) of more than 70%, the erosion resistance is lowered. The low porosity part 5a preferably has a porosity P1(%) of 5 to 70% and more preferably 5 to 50%.

Each high porosity part 5b has a porosity P2(%) satisfying Formula (1), and if Formula (1) is not satisfied, the effect of preventing the inflow side plugging portions 5 from falling is unlikely to be achieved.

Formula (1) is an inequality in which the porosity P2(%) of high porosity parts 5b, the porosity P3(%) of a partition wall 1, and the open frontal area N1(%) of the cells 2 of a honeycomb structure 4 are variables. The partition wall 1 preferably has a porosity P3(%) of 40 to 70% and more preferably 45 to 65%, for example. The open frontal area N1(%) of the cells 2 is preferably 55 to 85% and more preferably 62 to 83%, for example.

The preferred range of the length L1 (mm) of a low porosity part 5a in the extending direction of the cells 2 can be specified as below depending on the porosity P1(%) of the low porosity part 5a. In other words, when the porosity P1(%) of a low porosity part 5a is within the range of 65%<P1≤70%, Formula (2) is preferably satisfied. When the porosity P1(%) of a low porosity part 5a is within the range of 40%<P1≤65%, Formula (3) is preferably satisfied. When the porosity P1(%) of a low porosity part 5a is 40% or less, Formula (4) is preferably satisfied.

L1≥0.1339×P1−7.517 Formula (2):

(In Formula (2), P1(%) satisfies 65%<P1≤70%)

L1≥0.0245×P1−0.4375 Formula (3):

(In Formula (3), P1(%) satisfies 40%<P1≤65%)

L1≥0.4 Formula (4):

If the length L1 (mm) of a low porosity part 5a in the extending direction of the cells 2 satisfies none of Formulae (2) to (4), the low porosity part 5a substantially has an excessively small thickness, and the low porosity part 5a may be easily lost due to the abrasion (corrosion wastage) of the low porosity part 5a. Hereinafter, the “length L1 of a low porosity part 5a in the extending direction of the cells 2” is also simply called “length L1 of a low porosity part 5a”.

The method of measuring the porosity of inflow side plugging portions 5, that is, the porosity P1(%) of low porosity parts 5a and the porosity P2(%) of high porosity parts 5b, will next be described. To measure the porosity of inflow side plugging portions 5, a scanning electron microscope (hereinafter, also called “SEM”) is used to record 10 visual fields in the inflow side plugging portions 5 on a cross section orthogonal to the extending direction of the cells 2. The 10 visual fields to be recorded are 5 visual fields selected along the X axis direction and 5 visual fields selected along the Y axis direction on the cross section, from the partition wall 1 passing through the center of the honeycomb filter 100. Next, each recorded image is binarized by image analysis into cavity areas (i.e., pore areas) and areas other than the cavities. Subsequently, the proportion of the cavity areas in each image is calculated, and the average is determined. The average determined as above is regarded as the porosity of the inflow side plugging portions 5. By adjusting the recording position of a cross section in the extending direction of the cells 2, the porosity P1(%) of the low porosity parts 5a and the porosity P2(%) of the high porosity parts 5b can be separately determined.

If the length L2 (mm) of a high porosity part 5b in the extending direction of the cells 2 is less than 1 mm, the bonding face between the inflow side plugging portions 5 and the partition wall 1 is excessively small, and the effect of preventing the inflow side plugging portions 5 from falling is unlikely to be achieved. Hereinafter, the “length L2 of a high porosity part 5b in the extending direction of the cells 2” is also simply called “length L2 of a high porosity part 5b”. The high porosity part 5b preferably has a length L2 (mm) of 1 to 9.5 mm and more preferably 2 to 6.5 mm.

Each inflow side plugging portion 5 preferably has a length L3 (mm) of 3 to 10 mm and more preferably 5 to 7 mm in the extending direction of the cells 2. The length L3 (mm) of the inflow side plugging portion 5 in the extending direction of the cells 2 is the sum of the length L1 (mm) of the low porosity part 5a and the length L2 (mm) of the high porosity part 5b. Hereinafter, the “length L3 of an inflow side plugging portion 5 in the extending direction of the cells 2” is also simply called “length L3 of an inflow side plugging portion 5”. If the length L3 (mm) of an inflow side plugging portion 5 is less than 3 mm, a scoop or chip of the inflow end face 11 of the honeycomb filter 100 may result in elimination of the inflow side plugging portion 5, and thus such a condition is unfavorable. If the length L3 (mm) of an inflow side plugging portion 5 is more than 10 mm, the gas passage area is reduced to increase the pressure loss, and thus such a condition is unfavorable.

The absolute value of the difference between the porosity P2(%) of the high porosity part 5b and the porosity P1(%) of the low porosity part 5a (|P2(%)−P1(%)|) is preferably 1 to 75%, more preferably 10 to 75%, and particularly preferably 20 to 75%.

The outflow side plugging portions 6 preferably have a substantially constant porosity in the extending direction of the cells 2. In other words, each outflow side plugging portion 6 preferably has neither the low porosity part 5a nor the high porosity part 5b as in the inflow side plugging portion 5.

In the honeycomb structure 4, the partition wall 1 preferably has a porosity P3(%) of 40 to 70% and more preferably 45 to 65%. The honeycomb filter 100 of the embodiment exerts more marked effects when including a high porosity honeycomb structure 4 including a partition wall 1 having a porosity P3 of 40 to 70%. The porosity P3(%) of a partition wall 1 is determined by mercury porosimetry. The porosity P3(%) of a partition wall 1 can be determined by using AutoPore 9500 (trade name) manufactured by Micromeritics, for example. The porosity P3(%) of a partition wall 1 can be determined by using a test piece prepared by partially cutting the partition wall 1 out from a honeycomb structure 4. The porosity P3(%) of the partition wall 1 is preferably constant in the whole region of the honeycomb structure 4. For example, the absolute value of the difference between the maximum porosity P3(%) of the partition wall 1 and the minimum porosity P3(%) of the partition wall 1 is preferably 10% or less.

In the honeycomb structure 4, the partition wall 1 preferably has a thickness of 0.127 to 0.381 mm, more preferably 0.152 to 0.305 mm, and particularly preferably 0.203 to 0.254 mm. The thickness of a partition wall 1 can be determined by using a scanning electron microscope or a microscope, for example. If the thickness of a partition wall 1 is less than 0.127 mm, sufficient strength may not be achieved. If the thickness of a partition wall 1 is more than 0.381 mm, the pressure loss of such a honeycomb filter 100 may increase.

The cells 2 defined by the partition wall 1 may have any shape. Examples of the shape of the cells 2 in a cross section orthogonal to the extending direction of the cells 2 include a polygonal shape, a circular shape, and an elliptical shape. Examples of the polygonal shape include a triangular shape, a quadrangular shape, a pentagonal shape, a hexagonal shape, and an octagonal shape. The shape of the cells 2 is preferably a triangular shape, a quadrangular shape, a pentagonal shape, a hexagonal shape, or an octagonal shape. As for the shape of the cells 2, all the cells 2 may have the same shape, or the cells may have different shapes. For example, not shown in the drawings, quadrangular cells and octagonal cells may be mixed. As for the size of the cells 2, all the cells 2 may have the same size, or the cells may have different sizes. For example, not shown in the drawings, of a plurality of cells, some cells may have a larger size, and the other cells may have a smaller size. In the present invention, the cell means a space surrounded by a partition wall.

The cell density of the cells 2 defined by the partition wall 1 is preferably 15 to 78 cells/cm² and more preferably 31 to 62 cells/cm². When having such a structure, the honeycomb filter 100 can maintain the PM trapping performance and can suppress an increase in pressure loss.

The circumferential wall 3 of the honeycomb structure 4 may be formed integrally with the partition wall 1 or may be a circumferential coating layer formed by applying a circumferential coating material so as to environ the partition wall 1. Not shown in the drawings, the circumferential coating layer can be provided as follows in a production process: a partition wall and a circumferential wall are integrally formed, then the formed circumferential wall is removed by a known technique such as grinding, and a circumferential coating layer is provided on the circumference of the partition wall.

The honeycomb structure 4 may have any shape. Examples of the shape of the honeycomb structure 4 include a pillar shape in which an inflow end face 11 and an outflow end face 12 have a circular shape, an elliptical shape, a polygonal shape, or the like.

The dimensions of the honeycomb structure 4, for example, the length from the inflow end face 11 to the outflow end face 12 and the dimensions of a cross section orthogonal to the extending direction of the cells 2 in the honeycomb structure 4 are not limited to particular values. Each dimension can be appropriately set so as to achieve the optimum purification performance when the honeycomb filter 100 is used as a filter for purifying an exhaust gas. For example, the length from the inflow end face 11 to the outflow end face 12 of the honeycomb structure 4 is preferably 80 to 170 mm and more preferably 90 to 160 mm. The area of a cross section orthogonal to the extending direction of the cells 2 of the honeycomb structure 4 is preferably 50 to 210 cm² and more preferably 80 to 180 cm².

The partition wall 1 may be formed from any material. For example, the material of the partition wall 1 preferably includes at least one selected from the group consisting of silicon carbide, cordierite, a silicon-silicon carbide composite material, a cordierite-silicon carbide composite material, silicon nitride, mullite, alumina, and aluminum titanate.

The inflow side plugging portions 5 and the outflow side plugging portions 6 may also be formed from any material. For example, a similar material to the above materials of the partition wall 1 can be used. In each inflow side plugging portion 5, the low porosity part 5a and the high porosity part 5b may be formed from the same material or from different materials.

Other embodiments of the honeycomb filter of the present invention will next be described. Another embodiment of the honeycomb filter of the present invention is a honeycomb filter 200 as shown in FIG. 5. FIG. 5 is a schematic sectional view showing another embodiment of the honeycomb filter of the present invention. FIG. 5 shows a cross section corresponding to the cross section taken along the line A-A′ in FIG. 2.

The honeycomb filter 200 shown in FIG. 5 includes a honeycomb structure 4, inflow side plugging portions 25, and outflow side plugging portions (not shown). In the honeycomb filter 200 of the embodiment, the structures of a low porosity part 25a and a high porosity part 25b in each inflow side plugging portion 25 differ from the low porosity part 5a and the high porosity part 5b in the honeycomb filter 100 shown in FIG. 1 to FIG. 4. In the honeycomb filter 200, the components other than the low porosity parts 25a and the high porosity parts 25b of the inflow side plugging portions 25 preferably have similar structures to those of the corresponding components of the honeycomb filter 100 shown in FIG. 1 to FIG. 4. In the honeycomb filter 200 shown in FIG. 5, identical or corresponding components to those in the honeycomb filter 100 shown in FIG. 1 to FIG. 4 are indicated by identical reference numerals and will not specifically described.

In the honeycomb filter 200 shown in FIG. 5, the end of the low porosity part 25a of each inflow side plugging portion 25 protrudes outward from the inflow end face 11 of the honeycomb structure 4. Also in the honeycomb filter 200 having such a structure, by setting each high porosity part 25b having a porosity satisfying Formula (1) to have a length L2 (mm) of 1 mm or more, similar advantageous effects to the honeycomb filter 100 shown in FIG. 1 to FIG. 4 can be achieved. Also in the honeycomb filter 200, each low porosity part 25a has a porosity P1(%) of 70% or less.

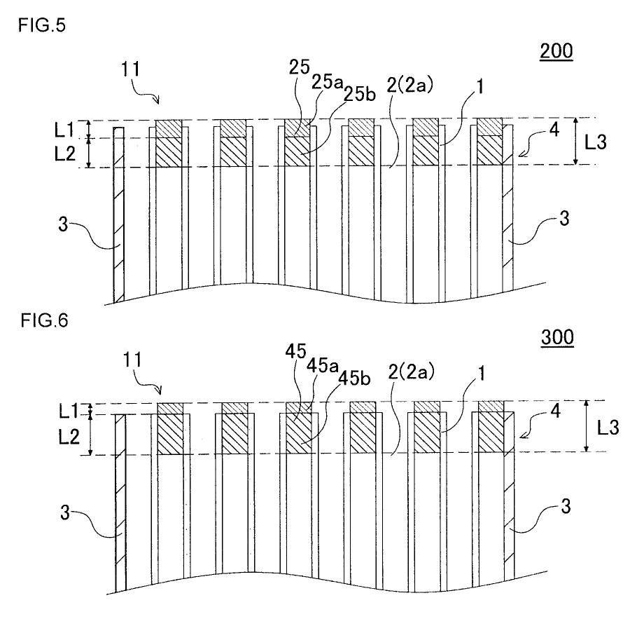

Still another embodiment of the honeycomb filter of the present invention will next be described. Still another embodiment of the honeycomb filter of the present invention is a honeycomb filter 300 as shown in FIG. 6. FIG. 6 is a schematic sectional view showing still another embodiment of the honeycomb filter of the present invention. FIG. 6 shows a cross section corresponding to the cross section taken along the line A-A′ in FIG. 2.

The honeycomb filter 300 shown in FIG. 6 includes a honeycomb structure 4, inflow side plugging portions 45, and outflow side plugging portions (not shown). Also in the honeycomb filter 300 of the embodiment, the structures of a low porosity part 45a and a high porosity part 45b in each inflow side plugging portion 45 differ from the low porosity part 5a and the high porosity part 5b in the honeycomb filter 100 shown in FIG. 1 to FIG. 4. In the honeycomb filter 300, the components other than the low porosity parts 45a and the high porosity parts 45b of the inflow side plugging portions 45 preferably have similar structures to those of the corresponding components of the honeycomb filter 100 shown in FIG. 1 to FIG. 4. In the honeycomb filter 300 shown in FIG. 6, identical or corresponding components to those in the honeycomb filter 100 shown in FIG. 1 to FIG. 4 are indicated by identical reference numerals and will not specifically described.

In the honeycomb filter 300 shown in FIG. 6, the low porosity part 45a of each inflow side plugging portion 45 is located outside the inflow end face 11 of the honeycomb structure 4. Also in the honeycomb filter 300 having such a structure, by setting each high porosity part 45b having a porosity satisfying Formula (1) to have a length L2 (mm) of 1 mm or more, similar advantageous effects to the honeycomb filter 100 shown in FIG. 1 to FIG. 4 can be achieved. Also in the honeycomb filter 300, each low porosity part 45a has a porosity P1(%) of 70% or less.

(2) Method for Producing Honeycomb Filter:

The honeycomb filter of the present invention may be produced by any method and can be produced by the following method, for example. First, a plastic kneaded material for producing a honeycomb structure is prepared. The kneaded material for producing a honeycomb structure can be prepared by adding appropriate additives such as a binder, a pore former, and water to a raw material selected, as a raw material powder, from the above preferred raw materials for partition walls.

Next, the kneaded material prepared as above is subjected to extrusion to give a pillar-shaped honeycomb formed body including a partition wall defining a plurality of cells and including a circumferential wall provided to environ the partition wall. The obtained honeycomb formed body is subsequently dried by microwaves and hot air, for example.

Next, at the open ends of the cells of the dried honeycomb formed body, plugging portions are provided. Specifically, for example, a mask is applied onto the inflow end face of the honeycomb formed body so as to cover inflow cells. The end of the honeycomb formed body with the mask is then immersed in a plugging slurry containing a plugging raw material for forming plugging portions, and the open ends of outflow cells without the mask are filled with the plugging slurry. The same process as above is subsequently performed for the outflow end face of the honeycomb formed body to fill the open ends of the inflow cells with a plugging slurry.

To produce the honeycomb filter of the present invention, such a process as below is performed when the plugging portions are provided on the inflow end face side of the honeycomb formed body, thus preparing inflow side plugging portions each having a low porosity part and a high porosity part. First, a plugging raw material for high porosity is pushed or inserted from the end face of the honeycomb formed body, and then a plugging raw material for low porosity is sequentially pushed or inserted, yielding inflow side plugging portions.

Next, the honeycomb formed body having the plugging portions each provided at one open end of a cell is burned to give the honeycomb filter of the present invention. The burning temperature and the burning atmosphere vary with raw materials, and a person skilled in the art can select the burning temperature and the burning atmosphere suitable for a selected material.

### EXAMPLES

The present invention will be specifically described hereinafter with reference to examples, but the present invention is not intended to be limited to these examples.

### Example 1

To 100 parts by mass a cordierite forming raw material, 10 parts by mass of a pore former, 20 parts by mass of a dispersing medium, and 1 part by mass of an organic binder were added, and the whole was mixed and kneaded to give a kneaded material. The cordierite forming raw material contained alumina, aluminum hydroxide, kaolin, talc, and silica. The dispersing medium was water. The organic binder was methylcellulose. The dispersing agent was dextrin. The pore former was a coke having an average particle diameter of 15 μm.

The kneaded material was next extruded by using a die for preparing a honeycomb formed body, giving a honeycomb formed body having a round pillar shape as a whole. The shape of the cells in the honeycomb formed body was quadrangular.

The honeycomb formed body was then dried in a microwave dryer and further completely dried in a hot-air drier. Both end faces of the honeycomb formed body were cut down for adjustment to an intended size.

A plugging material for forming plugging portions was next prepared. The plugging material contained the cordierite forming raw material, 1.5% by mass of a foamable resin (a copolymer with acrylonitrile, having an average particle diameter of 50 μm and a shell wall thickness of 0.2 μm), and 30% by mass of water. The plugging material had a viscosity (25° C.) of 280 dPa·s. The viscosity of the plugging material was determined with a rotational viscometer.

The above plugging material was used to form inflow side plugging portions at the open ends of cells on the inflow end face side of the dried honeycomb formed body. Specifically, a mask was applied onto the inflow end face of the honeycomb formed body so as to cover inflow cells. The end of the honeycomb formed body with the mask was then immersed in a plugging material for forming plugging portions having a high porosity, and the open ends of outflow cells without the mask were filled with the plugging material. The honeycomb formed body was subsequently immersed in a plugging material for forming plugging portions having a low porosity, and low porosity parts of the inflow side plugging portions were formed.

A mask was next applied also onto the outflow end face of the honeycomb formed body so as to cover the outflow cells. The end of the honeycomb formed body with the mask was then immersed in a plugging material, and the open ends of the inflow cells without the mask were filled with the plugging material. As described above, the outflow side plugging portions were formed at the open ends of cells on the outflow end face side of the dried honeycomb formed body.

Next, the honeycomb formed body with the respective plugging portions was degreased and burned to yield a honeycomb filter of Example 1.

The honeycomb filter of Example 1 had a round pillar shape with a circular inflow end face and a circular outflow end face. The inflow end face and the outflow end face each had a diameter of 118.4 mm. The honeycomb filter had a length of 127.0 mm in the cell extending direction. The honeycomb filter of Example 1 had a partition wall thickness of 0.216 mm and a cell density of 46.5 cells/cm². Table 1 shows the partition wall thickness and cell density of the honeycomb filter. The porosity of the partition wall was determined with AutoPore 9500 (trade name) manufactured by Micromeritics.

In the honeycomb filter of Example 1, each inflow side plugging portion had a low porosity part having a porosity P1(%) of 70% on the inflow end face side and had a high porosity part having a porosity P2(%) of 80% on the outflow end face side. In the inflow side plugging portion, the low porosity part had a length L1 (mm) of 2 mm in the cell extending direction, and the high porosity part had a length L2 (mm) of 1 mm in the cell extending direction. Table 1 shows the results. The numerical value calculated by substituting the porosity P3(%) of the partition wall and the cell open frontal area N1(%) on the right side of Formula (1) was shown in “value of Formula (1) (%)” in Table 1. The numerical values calculated by substituting the porosity P1(%) of the low porosity part on the right sides of Formula (2) and Formula (3) were shown in “value of Formula (2) (%)” and “value of Formula (3) (%)”, respectively, in Table 1.

The porosities of the low porosity parts and high porosity parts of the inflow side plugging portions were determined by the following procedure. First, a scanning electron microscope was used to record 10 visual fields in the inflow side plugging portions on a cross section orthogonal to the cell extending direction. The 10 visual fields recorded were 5 visual fields selected along the X axis direction and 5 visual fields selected along the Y axis direction on the cross section, from the partition wall passing through the center of the honeycomb filter. Next, each recorded image was binarized by image analysis into cavity areas and areas other than the cavities. Subsequently, the proportion of the cavity areas in each image was calculated, and the average was determined as the porosity of the inflow side plugging portions. By adjusting the recording position of a cross section in the cell extending direction, the porosity of the low porosity parts and the porosity of the high porosity parts were separately determined.

The honeycomb filter of Example 1 was subjected to “canning breaking test” and “erosion resistance evaluation” by the following procedures. Table 4 shows the results.

(Canning Breaking Test)

First, the circumferential face of the honeycomb filter of Example 1 was wrapped with a non-expansion mat. The non-expansion mat was “INTERAM 1600HTE (trade name)” manufactured by 3M. The non-expansion mat had a basis weight of 1,700 g/m². To wrap the circumferential face with the non-expansion mat, the non-expansion mat was so placed that the end of the non-expansion mat was located at a boundary of plugging portions of the honeycomb filter. The honeycomb filter wrapped with the non-expansion mat was next inserted in a metal can, and the metal can was compressed until the bearing stress on the circumferential face of the honeycomb filter reached 1.0 MPa. Inserting and storing a honeycomb filter in a metal can is called “canning”. When no plugging portion was broken in the process of increasing the bearing stress to 1.0 MPa, such a sample was regarded as acceptance. When a plugging portion was broken in the process of increasing the bearing stress to 1.0 MPa, such a sample was regarded as failure.

(Erosion Resistance Evaluation)

First, SiC abrasive grains having a grain diameter of 50 μm and flying on a hot air generated by a gas burner were hit against the inflow end face of the honeycomb filter of Example 1, and the abrasion loss of the inflow side plugging portions of the honeycomb filter was determined. The SiC abrasive grains were applied from a pipe having a diameter of 20 mm in conditions of a temperature of 700° C. and a flow rate of 120 m/sec, for 5 minutes. When the average abrasion loss of inflow side plugging portions was less than 3 mm, such a sample was regarded as acceptance. When the average abrasion loss of inflow side plugging portions was 3 mm or more, such a sample was regarded as failure.

TABLE 1

| | Honeycomb structure | | | | | | | | | | |
|---|---|---|---|---|---|---|---|---|---|---|---|
| | | | Partition | | Low | | High | | | | |
| | Partition | | wall | Cell open | porosity part | | porosity part | | | | |
| | wall | Cell | porosity | frontal | Porosity | Length | Porosity | Length | Value of | Value of | Value of |
| | thickness | density | P3 | area N1 | P1 | L1 | P2 | L2 | Formula | Formula | Formula |
| | (mm) | (cells/cm²) | (%) | (%) | (%) | (mm) | (%) | (mm) | (1) (%) | (2) (mm) | (3) (mm) |
| Example 1 | 0.216 | 46.5 | 65 | 72.8 | 70 | 2 | 80 | 1 | 76.5 | 1.86 | — |
| Example 2 | 0.305 | 46.5 | 65 | 62.8 | 70 | 2 | 80 | 1 | 68.7 | 1.86 | — |
| Example 3 | 0.216 | 46.5 | 65 | 72.8 | 65 | 1.5 | 80 | 1 | 76.5 | — | 1.16 |
| Example 4 | 0.305 | 46.5 | 65 | 62.8 | 65 | 1.5 | 70 | 1 | 68.7 | — | 1.16 |
| Example 5 | 0.216 | 46.5 | 65 | 72.8 | 60 | 1.2 | 80 | 1 | 76.5 | — | 1.03 |
| Example 6 | 0.305 | 46.5 | 65 | 62.8 | 60 | 1.2 | 70 | 1 | 68.7 | — | 1.03 |
| Comparative | 0.216 | 46.5 | 65 | 72.8 | 75 | 3 | 80 | 1 | 76.5 | — | — |
| Example 1 | | | | | | | | | | | |
| Comparative | 0.305 | 46.5 | 65 | 62.8 | 75 | 3 | 80 | 1 | 68.7 | — | — |
| Example 2 | | | | | | | | | | | |
| Comparative | 0.216 | 46.5 | 65 | 72.8 | 80 | 3 | 80 | 1 | 76.5 | — | — |
| Example 3 | | | | | | | | | | | |
| Comparative | 0.305 | 46.5 | 65 | 62.8 | 80 | 3 | 80 | 1 | 68.7 | — | — |
| Example 4 | | | | | | | | | | | |
| Comparative | 0.216 | 46.5 | 65 | 72.8 | 60 | 2 | 70 | 1 | 76.5 | 1.86 | — |
| Example 5 | | | | | | | | | | | |
| Comparative | 0.305 | 46.5 | 65 | 62.8 | 60 | 2 | 65 | 1 | 68.7 | 1.86 | — |
| Example 6 | | | | | | | | | | | |
| Comparative | 0.216 | 46.5 | 65 | 72.8 | 60 | 2 | 80 | 0.5 | 76.5 | 1.86 | — |
| Example 7 | | | | | | | | | | | |
| Comparative | 0.305 | 46.5 | 65 | 62.8 | 60 | 2 | 70 | 0.5 | 68.7 | 1.86 | — |
| Example 8 | | | | | | | | | | | |

### Examples 2 to 6

The same procedure as for the honeycomb filter of Example 1 was performed except that the cell open frontal area N1(%) and the porosities P1(%) and P2(%) and lengths L1 (mm) and L2 (mm) in the cell extending direction of the low porosity part and high porosity part of each inflow side plugging portion were changed as shown in Table 1, yielding honeycomb filters. In Examples 2 to 6, the porosities P1(%) and P2(%) of the low porosity part and high porosity part were changed by changing the amount of the foamable resin when a plugging slurry was prepared to change the porosity of inflow side plugging portions.

### Examples 7 to 27

In Examples 7 to 27, the porosity P3(%) of the partition wall 1 was also changed as shown in Table 2 and Table 3, and honeycomb filters were produced. The porosity P3(%) of the partition wall 1, the cell open frontal area N1(%), and the porosities P1(%) and P2(%) and lengths L1 (mm) and L2 (mm) in the cell extending direction of the low porosity part and high porosity part of each inflow side plugging portion are as shown in Table 2 and Table 3.

### Comparative Examples 1 to 21

In Comparative Examples 1 to 21, honeycomb filters having such structures as shown in Table 1 to Table 3 were produced.

The honeycomb filters of Examples 2 to 27 and Comparative Examples 1 to 21 were also subjected to the “canning breaking test” and the “erosion resistance evaluation”. Table 4 to Table 6 show the results.

TABLE 2

| | Honeycomb structure | | | | | | | | | | |
|---|---|---|---|---|---|---|---|---|---|---|---|
| | | | Partition | | Low | | High | | | | |
| | Partition | | wall | Cell open | porosity part | | porosity part | | | | |
| | wall | Cell | porosity | frontal | Porosity | Length | Porosity | Length | Value of | Value of | Value of |
| | thickness | density | P3 | area N1 | P1 | L1 | P2 | L2 | Formula | Formula | Formula |
| | (mm) | (cells/cm²) | (%) | (%) | (%) | (mm) | (%) | (mm) | (1) (%) | (2) (mm) | (3) (mm) |
| Example 7 | 0.216 | 31.0 | 55 | 77.4 | 70 | 2 | 80 | 1 | 71.1 | 1.86 | — |
| Example 8 | 0.305 | 31.0 | 55 | 69 | 70 | 2 | 80 | 1 | 64.6 | 1.86 | — |
| Example 9 | 0.305 | 46.5 | 55 | 62.8 | 70 | 2 | 80 | 1 | 59.8 | 1.86 | — |
| Example 10 | 0.216 | 31.0 | 55 | 77.4 | 65 | 1.5 | 75 | 1 | 71.1 | — | 1.16 |
| Example 11 | 0.305 | 31.0 | 55 | 69 | 65 | 1.5 | 70 | 1 | 64.6 | — | 1.16 |
| Example 12 | 0.305 | 46.5 | 55 | 62.8 | 65 | 1.5 | 70 | 1 | 59.8 | — | 1.16 |
| Example 13 | 0.216 | 31.0 | 55 | 77.4 | 60 | 1.2 | 75 | 1 | 71.1 | — | 1.03 |
| Example 14 | 0.305 | 31.0 | 55 | 69 | 60 | 1.2 | 70 | 1 | 64.6 | — | 1.03 |
| Example 15 | 0.305 | 46.5 | 55 | 62.8 | 60 | 1.2 | 65 | 1 | 59.8 | — | 1.03 |
| Comparative | 0.216 | 31.0 | 55 | 77.4 | 75 | 3 | 80 | 1 | 71.1 | — | — |
| Example 9 | | | | | | | | | | | |
| Comparative | 0.305 | 31.0 | 55 | 69 | 75 | 3 | 80 | 1 | 64.6 | — | — |
| Example 10 | | | | | | | | | | | |
| Comparative | 0.305 | 46.5 | 55 | 62.8 | 75 | 3 | 80 | 1 | 59.8 | — | — |
| Example 11 | | | | | | | | | | | |
| Comparative | 0.216 | 31.0 | 55 | 77.4 | 60 | 2 | 70 | 1 | 71.1 | 1.86 | — |
| Example 12 | | | | | | | | | | | |
| Comparative | 0.305 | 31.0 | 55 | 69 | 55 | 2 | 60 | 1 | 64.6 | 1.86 | — |
| Example 13 | | | | | | | | | | | |
| Comparative | 0.305 | 46.5 | 55 | 62.8 | 50 | 2 | 55 | 1 | 59.8 | 1.86 | — |
| Example 14 | | | | | | | | | | | |
| Comparative | 0.216 | 31.0 | 55 | 77.4 | 60 | 2 | 75 | 0.5 | 71.1 | 1.86 | — |
| Example 15 | | | | | | | | | | | |
| Comparative | 0.305 | 31.0 | 55 | 69 | 55 | 2 | 70 | 0.5 | 64.6 | 1.86 | — |
| Example 16 | | | | | | | | | | | |
| Comparative | 0.305 | 46.5 | 55 | 62.8 | 50 | 2 | 65 | 0.5 | 59.8 | 1.86 | — |
| Example 17 | | | | | | | | | | | |

TABLE 3

| | Honeycomb structure | | | | | | | | | | |
|---|---|---|---|---|---|---|---|---|---|---|---|
| | | | Partition | | Low | | High | | | | |
| | Partition | | wall | Cell open | porosity part | | porosity part | | | | |
| | wall | Cell | porosity | frontal | Porosity | Length | Porosity | Length | Value of | Value of | Value of |
| | thickness | density | P3 | area N1 | P1 | L1 | P2 | L2 | Formula | Formula | Formula |
| | (mm) | (cells/cm²) | (%) | (%) | (%) | (mm) | (%) | (mm) | (1) (%) | (2) (mm) | (3) (mm) |
| Example 16 | 0.127 | 55.8 | 48 | 81.9 | 70 | 2 | 75 | 1 | 68.3 | 1.86 | — |
| Example 17 | 0.152 | 34.1 | 48 | 83 | 70 | 2 | 75 | 1 | 69.2 | 1.86 | — |
| Example 18 | 0.216 | 31.0 | 48 | 77.4 | 70 | 2 | 75 | 1 | 64.9 | 1.86 | — |
| Example 19 | 0.305 | 46.5 | 48 | 62.8 | 70 | 2 | 75 | 1 | 53.6 | 1.86 | — |
| Example 20 | 0.127 | 55.8 | 48 | 81.9 | 65 | 1.5 | 70 | 1 | 68.3 | — | 1.16 |
| Example 21 | 0.152 | 34.1 | 48 | 83 | 65 | 1.5 | 70 | 1 | 69.2 | — | 1.16 |
| Example 22 | 0.216 | 31.0 | 48 | 77.4 | 65 | 1.5 | 70 | I | 64.9 | — | 1.16 |
| Example 23 | 0.305 | 46.5 | 48 | 62.8 | 65 | 1.5 | 70 | I | 53.6 | — | 1.16 |
| Example 24 | 0.127 | 55.8 | 48 | 81.9 | 60 | 1.2 | 70 | 1 | 68.3 | — | 1.03 |
| Example 25 | 0.152 | 34.1 | 48 | 83 | 60 | 1.2 | 70 | 1 | 69.2 | — | 1.03 |
| Example 26 | 0.216 | 31.0 | 48 | 77.4 | 60 | 1.2 | 70 | 1 | 64.9 | — | 1.03 |
| Example 27 | 0.305 | 46.5 | 48 | 62.8 | 60 | 1.2 | 70 | 1 | 53.6 | — | 1.03 |
| Comparative | 0.127 | 55.8 | 48 | 81.9 | 70 | 2 | 80 | 0.5 | 68.3 | 1.86 | — |
| Example 18 | | | | | | | | | | | |
| Comparative | 0.152 | 34.1 | 48 | 83 | 60 | 1.2 | 65 | 1 | 69.2 | — | 1.03 |
| Example 19 | | | | | | | | | | | |
| Comparative | 0.216 | 31.0 | 48 | 77.4 | 75 | 3 | 80 | 1 | 64.9 | — | — |
| Example 20 | | | | | | | | | | | |
| Comparative | 0.305 | 46.5 | 48 | 62.8 | 75 | 3 | 80 | 1 | 53.6 | — | — |
| Example 21 | | | | | | | | | | | |

TABLE 4

| | Canning | Erosion |
|---|---|---|
| | breaking test | resistance evaluation |
| Example 1 | Acceptance | Acceptance |
| Example 2 | Acceptance | Acceptance |
| Example 3 | Acceptance | Acceptance |
| Example 4 | Acceptance | Acceptance |
| Example 5 | Acceptance | Acceptance |
| Example 6 | Acceptance | Acceptance |
| Comparative Example 1 | Acceptance | Failure |
| Comparative Example 2 | Acceptance | Failure |
| Comparative Example 3 | Acceptance | Failure |
| Comparative Example 4 | Acceptance | Failure |
| Comparative Example 5 | Failure | Acceptance |
| Comparative Example 6 | Failure | Acceptance |
| Comparative Example 7 | Failure | Acceptance |
| Comparative Example 8 | Failure | Acceptance |

TABLE 5

| | Canning | Erosion |
|---|---|---|
| | breaking test | resistance evaluation |
| Example 7 | Acceptance | Acceptance |
| Example 8 | Acceptance | Acceptance |
| Example 9 | Acceptance | Acceptance |
| Example 10 | Acceptance | Acceptance |
| Example 11 | Acceptance | Acceptance |
| Example 12 | Acceptance | Acceptance |
| Example 13 | Acceptance | Acceptance |
| Example 14 | Acceptance | Acceptance |
| Example 15 | Acceptance | Acceptance |
| Comparative Example 9 | Acceptance | Failure |
| Comparative Example 10 | Acceptance | Failure |
| Comparative Example 11 | Acceptance | Failure |
| Comparative Example 12 | Failure | Acceptance |
| Comparative Example 13 | Failure | Acceptance |
| Comparative Example 14 | Failure | Acceptance |
| Comparative Example 15 | Failure | Acceptance |
| Comparative Example 16 | Failure | Acceptance |
| Comparative Example 17 | Failure | Acceptance |

TABLE 6

| | Canning | Erosion |
|---|---|---|
| | breaking test | resistance evaluation |
| Example 16 | Acceptance | Acceptance |
| Example 17 | Acceptance | Acceptance |
| Example 18 | Acceptance | Acceptance |
| Example 19 | Acceptance | Acceptance |
| Example 20 | Acceptance | Acceptance |
| Example 21 | Acceptance | Acceptance |
| Example 22 | Acceptance | Acceptance |
| Example 23 | Acceptance | Acceptance |
| Example 24 | Acceptance | Acceptance |
| Example 25 | Acceptance | Acceptance |
| Example 26 | Acceptance | Acceptance |
| Example 27 | Acceptance | Acceptance |
| Comparative Example 18 | Failure | Acceptance |
| Comparative Example 19 | Failure | Acceptance |
| Comparative Example 20 | Acceptance | Failure |
| Comparative Example 21 | Acceptance | Failure |

(Results)

The honeycomb filters of Examples 1 to 27 resulted in acceptance in both the “canning breaking test” and the “erosion resistance evaluation”. The honeycomb filters of Comparative Examples 1 to 21 resulted in failure in either the “canning breaking test” or the “erosion resistance evaluation”. In particular, honeycomb filters including low porosity parts having a porosity P1 of more than 70% resulted in failure in the “erosion resistance evaluation”. Honeycomb filters including a high porosity part having a porosity P2 of less than the value of Formula (1) and honeycomb filters including a high porosity part having a length L2 of less than 1 mm resulted in failure in the “canning breaking test”.

### INDUSTRIAL APPLICABILITY

The honeycomb filter of the present invention can be used as a filter trapping particulate matters in an exhaust gas.

### DESCRIPTION OF REFERENCE NUMERALS

1: partition wall
2: cell
2a: inflow cell
2b: outflow cell
3: circumferential wall
4: honeycomb structure
5, 25, 45: inflow side plugging portion
5a, 25a, 45a: low porosity part
5b, 25b, 45b: high porosity part
6: outflow side plugging portion
11: inflow end face
12: outflow end face
100, 200, 300: honeycomb filter

What is claimed is:

1. A honeycomb filter comprising:
a pillar-shaped honeycomb structure including a porous partition wall provided to surround a plurality of cells serving as fluid passages extending from an inflow end face to an outflow end face;
inflow side plugging portions provided on a side of the inflow end face at ends of predetermined cells of the plurality of cells; and
outflow side plugging portions provided on a side of the outflow end face at ends of residual cells of the plurality of cells, wherein
the inflow side plugging portions and the outflow side plugging portions are formed from a porous body,
each inflow side plugging portion includes, on a side of the inflow end face in an extending direction of the cells, a low porosity part having a porosity P1(%) of 70% or less and includes, on a side of the outflow end face in an extending direction of the cells, a high porosity part having a higher porosity than the low porosity part,
the high porosity part has a porosity P2(%) satisfying Formula (1):
P2≥(0.8904×P3)+(0.7716×N1)−37.585 Formula (1):
(in Formula (1), P3(%) represents a porosity (%) of the partition wall; and N1(%) represents an open frontal area (%) of the cells in the honeycomb structure), and
the high porosity part has a length L2 (mm) of 1 mm or more in the extending direction of the cells.

2. The honeycomb filter according to claim 1, wherein the low porosity part has a length L1 (mm) satisfying Formula (2) in the extending direction of the cells:
L1≥0.1339×P1−7.517 Formula (2):
(in Formula (2), P1(%) satisfies 65%<P1≤70%).

3. The honeycomb filter according to claim 1, wherein the low porosity part has a length L1 (mm) satisfying Formula (3) in the extending direction of the cells:
L1≥0.0245×P1−0.4375 Formula (3):
(in Formula (3), P1(%) satisfies 40%<P1≤65%).

4. The honeycomb filter according to claim 1, wherein the low porosity part has a porosity P1(%) of 40% or less and has a length L1 (mm) satisfying Formula (4) in the extending direction of the cells:
L1≥0.4. Formula (4):

5. The honeycomb filter according to claim 1, wherein the high porosity part has a length L2 (mm) of 1 to 9.5 mm in the extending direction of the cells.

6. The honeycomb filter according to claim 2, wherein the high porosity part has a length L2 (mm) of 1 to 9.5 mm in the extending direction of the cells.

7. The honeycomb filter according to claim 3, wherein the high porosity part has a length L2 (mm) of 1 to 9.5 mm in the extending direction of the cells.

8. The honeycomb filter according to claim 4, wherein the high porosity part has a length L2 (mm) of 1 to 9.5 mm in the extending direction of the cells.

9. The honeycomb filter according to claim 1, wherein the low porosity part has a porosity P1(%) of 5 to 70%.

10. The honeycomb filter according to claim 2, wherein the low porosity part has a porosity P1(%) of 5 to 70%.

11. The honeycomb filter according to claim 3, wherein the low porosity part has a porosity P1(%) of 5 to 70%.

12. The honeycomb filter according to claim 4, wherein the low porosity part has a porosity P1(%) of 5 to 70%.

13. The honeycomb filter according to claim 1, wherein an absolute value of a difference between the porosity P2(%) of the high porosity part and the porosity P1(%) of the low porosity part is 1 to 75%.

14. The honeycomb filter according to claim 2, wherein an absolute value of a difference between the porosity P2(%) of the high porosity part and the porosity P1 (%) of the low porosity part is 1 to 75%.

15. The honeycomb filter according to claim 3, wherein an absolute value of a difference between the porosity P2(%) of the high porosity part and the porosity P1(%) of the low porosity part is 1 to 75%.

16. The honeycomb filter according to claim 4, wherein an absolute value of a difference between the porosity P2(%) of the high porosity part and the porosity P1(%) of the low porosity part is 1 to 75%.
